(19) United States
(12) Patent Application Publication
(10) Pub. No.: US 2004/0176107 A1
(43) Pub. Date: Sep. 9, 2004

(54) Methods and systems for position based tasks for wireless devices

(76) Inventor: Lovleen Chadha, San Diego, CA (US)

Correspondence Address: Siemens Corporation, Attn: Elsa Keller, Intellectual Property Department, 170 Wood Avenue South, Iselin, NJ, 08830, US

(21) Appl. No.: 10/360,460

(22) Filed: Feb. 7, 2003

(51) Int. Cl. H04Q 7/20

(52) U.S. Cl. 455/456.5; 455/457

(57) ABSTRACT

Systems and methods for providing a wireless device with advanced location-based task/reminder functionality. The system provides the wireless network infrastructure equipment with a server for exchanging data information with a remote wireless device, and a position detector coupled with the server. The server generates an event trigger signal sent to the wireless device when a predefined condition based on the position of the remote wireless device is met. The wireless network service provider can operate the advanced location-based task/reminder service for existing wireless devices, with minimal modification of the users' wireless devices.

### BACKGROUND OF THE INVENTION

The present invention relates generally to providing more advanced organizer functionalities, including position-based task reminders, to mobile devices.

Mobile devices, such as wireless phones, personal assistants and the like, typically have multiple applications. For example, many phones and/or personal digital assistants include some limited integrated organizer functionality with a calendar, an address book, and a task list. In particular, a calendar or task list function will remind the user about a task or event. This function is usually time-based, i.e., it is triggered by a specific time which the user previously associated with that specific task or event. Once the time or a predefined time range within which the respective event takes place has been reached, a reminder signal or alarm will be generated by the mobile device.

Other options to trigger a reminder may be desirable in wireless devices having organizer functionality. However, adding additional functionality to such wireless devices can increase the costs of producing wireless devices, due to the need for additional hardware parts/components to each of the devices. Moreover, such additional hardware parts/components undesirably may decrease the battery lifetime of the mobile devices. Further, the use of additional hardware within the wireless device will increase the weight and size of the wireless device, diminishing the market appeal of the bulkier device to consumers desiring sleeker, lighter products.

It is desirable to have alternative and more sophisticated task reminder functions useable with wireless devices without the disadvantages mentioned above.

### SUMMARY OF THE INVENTION

The present invention provides systems and methods to improve and enhance mobile devices with more sophisticated functionality of location-based task reminders.

According to a specific embodiment, the present invention provides a system for for causing a wireless device to provide a location-based task functionality. The system includes a server for remotely exchanging data information with the wireless device, and a position detector logically coupled with the server. The position detector determines a position of a remote wireless device. The server generates an event trigger signal and sends the event trigger signal to wireless device if a predefined condition based on the position is met. The user of the wireless device configures the predefined condition on the server.

According to another specific embodiment, the present invention provides a method of operating a service using wireless network infrastructure equipment to provide a wireless device with a location-based task functionality. The method includes the steps of determining a position of a remote wireless device, and providing a server within the wireless network infrastructure equipment. The determining step is performed using the wireless network infrastructure equipment which includes a Position/Location Detector, and the server includes a Task Management Engine for administering the generation and transmission of an event trigger signal to the wireless device if a predefined condition based on the position is met. The method also includes the step of receiving configuration input to define the predefined condition on the server.

In some embodiments, the wireless device and the remote wireless device whose position is being determined are the same device; in other embodiments the remote wireless device whose position is being determined is different from the wireless device which is receiving the event trigger signal.

A more complete understanding of the present invention and advantages thereof may be acquired by referring to the following description taken in conjunction with the accompanying drawings, in which like reference numbers indicate like features.

### BRIEF DESCRIPTION OF THE DRAWINGS

FIG. 1 shows a general block diagram of the architecture of the present invention;

FIG. 2 shows a first embodiment according to the present invention; and

FIG. 3 shows a flow chart of a method according to the present invention.

### DETAILED DESCRIPTION OF SPECIFIC EMBODIMENTS

In many instances, task reminders triggered by a particular position of a user would be useful, besides a time-based task reminder typically available in a wireless device such as a cellular phone or personal digital assistant (PDA). The present invention provides an efficient way to provide more advanced position-based task reminders configurable by a user of a wireless or mobile device. With the present invention, the wireless service provider maintains and operates the equipment needed for providing the service of position-based task reminders. Existing customers of such wireless service providers can thus upgrade to more advanced position-based task reminders with their existing mobile devices without needing to purchase a new mobile device. Rather, the users can subscribe on a fee basis for such service from the wireless service provider, which allows the service provider to distinguish itself from other providers and desirably serves as another source of profit. The fee charged can be a fee per each task or reminder that is initiated, or a flat fee for unlimited tasks/reminders (or certain levels of usage) during a certain billing period.

According to the invention, a wireless device is thus enabled to trigger a reminder for a task based on the location or position of the user having the device. Exemplary reminder entries in a task reminder database of the present invention could be the reminder “Remind me to buy item X whenever I pass near store Y” or the reminder “Remind me to drop off item W whenever I pass location Z”, etc. Whenever the mobile device enters one of the zones defined by the location-based task reminder entries, the respective reminder is sent by the wireless service provider's network equipment to the wireless device to alert the user that a task (previously defined by the user) should be done since the user is within the region of a previously specified location.

The system and methods according to the present invention allow the user to associate user-defined actions with the position of the user's wireless device. Rules defining the device's proximity to user-specified positions or locations are used to send a trigger signal to the wireless device which provides the reminder regarding particular actions or tasks. In order to enable the system in some embodiments, the user can install a thin software application providing the user interface onto the user's mobile device which communicates with the service provider's network equipment and enables the triggering of the reminders/actions on the device. In other embodiments, the thin software application may be optional since the reminders can be sent directly by the network system as messages like SMS. In order to configure and delete/modify the reminders/actions associated with the position-rules, the user can access a user setup software application made available on a web server via the mobile device's interne t interface application, the user can access the setup software application made available on a web server via the user's personal computer or laptop linked via landline or wireless telephone network to the service provider's network equipment, and/or the user can access the setup software application installed on the user's personal computer linked via landline or wireless telephone network to the service provider's network equipment.

The position or location of a particular wireless device is determined or provided by the network equipment part, as will be described further below, of a wireless network, such as cellular networks like GSM, CDMA, TDMA, and other networks with such capabilities. For the sake of ease in explanation, the present description explains the system of the present invention in the context of a GSM network. However, the present invention will be applicable to other wireless networks besides GSM. This system enables users of a wireless device to associate tasks/reminders with the position of a defined wireless device (their own device or someone else's device). The position information determined by the wireless service provider's network equipment, in accordance with various specific embodiments of the present invention, can be generated from spatial coordinates (e.g., longitude/latitude, possibly altitude in some embodiments); postal ZIP code; telephone area code; mailing address such as a combination of one or more of a block number, a street address, city, state, country, etc.; base station identifier; cell/sector identifier; and/or any other identifier that can be used to identify a position. The step of obtaining position information may be repeated in predefined time intervals. Depending on the position information, the time intervals can be varied. A direction of movement can be determined from successive position information. With the present invention, the wireless devices themselves do not require any use of device-incorporated or device-attached position determination hardware, such as a GPS module, in order to provide the position-based task reminders.

With the availability of position information on wireless networks, position-based task reminders can be generated and sent to the wireless device when a predefined condition is met. As examples, the predefined condition can be when the position of the wireless device matches a predefined location, when the position of the wireless device is within a predefined area, when the position of the wireless device is not within or does not match a predefined area, when the position of the wireless device changes from a first area to a second area, or when the position of the wireless device is approaching a predefined area (such as when the direction of the device is calculated by the network). Further, the predefined condition causing the task reminder to be sent can be time-based, e.g., the predefined position match (or mismatch) may be required to be maintained for a predefined time period to meet the condition.

Thus, when the wireless device is located exactly at a previously-specified position, the present invention's network system can provide the device with the associated reminder. However, users may define a proximity parameter (radius, diameter, distance in street blocks, etc.) that extends the triggering of the reminder to a larger area than the exact position. For example, the presence of the person/device within a radius of 100 ft of location X could be configured to be sufficient to be considered as a position-match triggering the reminder being sent to the device. The actual proximity parameter used in any specific embodiment will depend on what kind of position information is being used e.g. spatial coordinates, ZIP codes, telephone area codes, etc.

A reminder of a task may involve the presentation of a prompt or message (e.g., short message service (SMS) message, with or without user-defined previously specified contents; an email, Instant Message or other message) to the user and/or the initiation of a user-defined previously specified action on the wireless device. In other embodiments, the presentation of a prompt or message to the user may involve audio, video, and/or text data.

According to some specific embodiments, the event trigger signal, in addition to or alternatively to generating a reminder alert within the wireless device, cause the start of an application within the wireless device, and/or activate a predefined operating mode of the wireless device. The application (e.g. C, C++, VB, Java, BREW application or other programming language application) may include an action from the group consisting of dialing a number, starting a web browser (with or without a previously specified user-defined URL), downloading or uploading (or pausing or resuming the same) a file from the web, enabling/disabling a menu or a function of the device, and/or controlling a function of the wireless device. The predefined operating mode can select a predefined profile/setting of the wireless device.

In other embodiments, the position information can be obtained for a first wireless device and the event trigger signal can be sent to a second wireless device. These embodiments can be desirable for multiple devices within a family, office, or other relationships where such information is mutually desired to be linked, where the location of a first user's device may be desired to trigger a reminder sent to a second user's device. For example, a child's mobile device leaving a predefined radius of a school or home zone might be configured to generate and send an event trigger signal to the parent's mobile device advising them that the child has strayed an unreasonable distance from the school or home and reminding the parent to call the child's mobile device.

The user can specify whether a particular action or task reminder specified by a particular rule is a one-time event or a recurring event. These rules also can be combined with date and/or time. Furthermore, the user can define a set of rules that must be fulfilled (all or one or a combination thereof) to trigger an action or task reminder. Users may also associate a sequence with the rules. Thus, a wide variety of rules that trigger an event or reminder can be implemented.

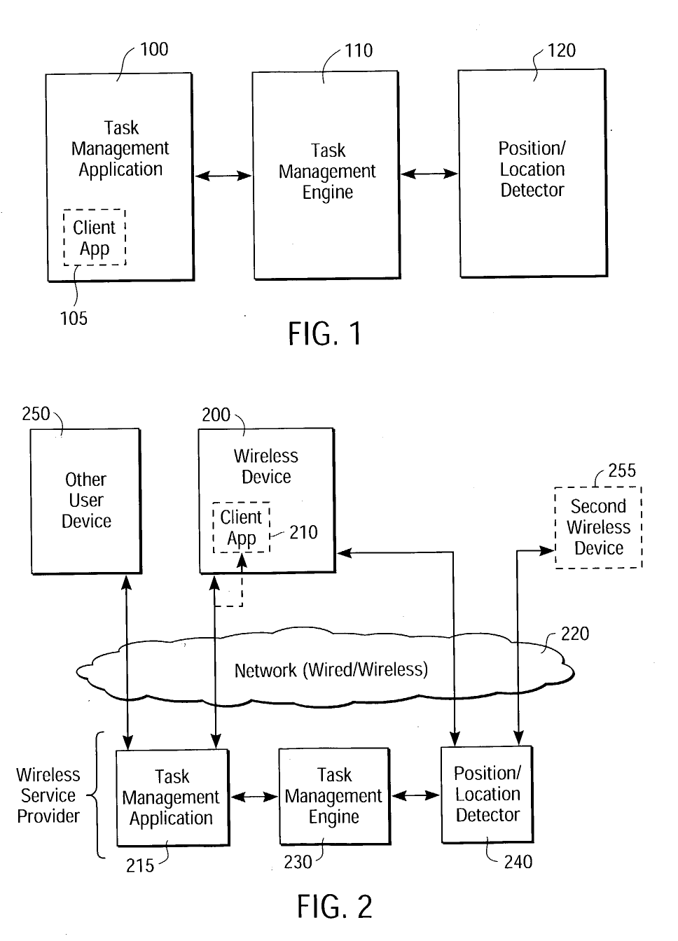

FIG. 1 shows a block diagram of the general architecture of the position-based task management system of the present invention. The system includes a Task Management Application 100 logically coupled to a Task Management Engine 110, which is logically coupled to a Position/Location Detector 120.

Task Management Application 100 acts as a front-end to the user, and receives inputs from the user and provides feedback to the user. Application 100 also allows the user to define the tasks/actions and associate them with the position-rules, in various ways as discussed above. Typically, a user will configure his reminders/actions and rules using the Task Management Client Application 100 interface. Task Management Client Application 100 passes this user-configured information to Task Management Engine 110. In some embodiments, Task Management Application 100 resident on the wireless service provider's network equipment can include an optional Client Application 105 installed on the wireless device, which provides reminders/actions to the user's mobile device and allows the wireless device to communicate with Task Management Application 100.

According to specific embodiments, the user may access the Task Management Application 100 interface using a separate personal computer (PC)/personal digital assistant (PDA), or the user may use the wireless/mobile device itself to access the application interface. The Task Management Application 100 interface might be deployed as any of the following: an application that executes on the wireless device itself (e.g., Client Application 105 in some embodiments); a web-based application that can be accessed using a PC/PDA or wireless devices; a computer-telephony application that can be accessed by a phone, PC/PDA or wireless device; or messaging services that use the wireless networks. A user input to Task Management Application 100 might be in any of the following forms: entering of x-y coordinates; showing a graphical map-based interface for specifying the locations; or selecting a location from a list of locations, which can be previously defined.

Task Management Engine 110 performs the core functionality of task management, i.e., tracking the position-events and comparing these to the position-rules that need to be executed. Task Management Engine 110 also obtains the position data from Position/Location Detector (or Calculator) 120. Thus, Task Management Engine 110 maintains a database of actions and task reminders and position-rules along with the mobile device's position information, which will be used to trigger the reminders/actions sent from Task Management Application 100 to the wireless device. Position/Location Detector 120 determines the position or location of the wireless device using the various location information discussed earlier using applicable wireless network location techniques (e.g., E-OTD, base station identifier, cell/sector identifiers).

Whenever a rule needs to be executed based on the wireless device's position determined by Position/Location Detector 120, Task Management Engine 110 passes the relevant information to the Task Management Application 100 so that it (in communication with the Client Application 105 in some embodiments) can cause the appropriate reminder to be alerted on the user's wireless device and/or carry out the required actions on the wireless device.

FIG. 2 shows specific embodiments of the present invention on a GSM environment. In these embodiments, the wireless device 200 is a GSM phone or device (which in some embodiments includes a Client Application 210 shown in dotted lines) that communicates via a network 220 with and is located remote from the Task Management Application 215, Task Management Engine 230 and Position/Location Detector 240. The GSM wireless infrastructure network has access to position coordinates of the wireless device 200 on a continuous basis via the Location Server (which can be used as Position/Location Detector 240). There exist many technologies, such as enhanced observed time difference (EOTD), base station identifier, cell site/sector identifiers, etc, utilizable in Position/Location Detector 240 that allow a network to calculate and monitor the location of a wireless device (in some embodiments, with the help of measurements reported by the device). Thus, a network-side position determination is utilized for the position-based-task-reminders of the present invention, and does not require any special hardware components in the wireless device. The system will operate with any wireless device whose user has access to a Task Management Application 215 (e.g., the user can use the wireless device 200's internet interface, such as a WAP browser application, to access via a web server having the Application 215; and/or the user can use another device 250, such as a PC or laptop having an internet browser application to access a web server having the Application 215). The system also is operable with a wireless device 200 whose position can be tracked by the network, and in some embodiments with a second wireless device 250 whose position can be tracked by the network and is linked in setup via Task Management Engine 230 to Task Management Application 215 (with Client Application 210 in some embodiments) sending reminders/actions to wireless device 200.

The entire implementation of position determination is maintained on the infrastructure network by the wireless service provider. Specifically, Task Management Application 215 is on a server which is part of the infrastructure network, Position/Location Detector 240 is part of the infrastructure network, and Task Management Engine 230 is on a server which is part of the infrastructure network. Application 215, Detector 240 and Engine 230 are all maintained by the wireless network service provider. It should be noted that the Task Management Engine 230 and the Location Detector 240 might be running on the same server or they might be deployed on separate servers, according to specific embodiments. In some embodiments, Application 215, Detector 240 and/or Engine 230 can be separate equipment or can be different logic/parts/modules of the same equipment/server.

In other embodiments, the Task Management Application 215 can also be deployed as a wireless application protocol (WAP) application on the network 220, and the wireless device 200 can access the Task Management Application 215 using a WAP browser. In these embodiments with an absence of a Task Management Client Application 210 on the wireless device 200 itself, Task Management Engine 230 can cause Task Management Client Application 210 to remotely initiate actions on the wireless device using existing wireless network infrastructure methods (e.g., using SMS or other message) to send an event trigger signal. Since the network 220 generally has access to the position coordinates of the wireless device 200 on a continuous basis and uses this database on Task Management Engine 230 to trigger actions/tasks via the Task Management Application 215, a service provider can use any of the native/non-native mechanisms to send information (such as actions/tasks) to the wireless device 200. The wireless device 200 may alert the user using audio/video/text prompts or perform the other required actions, according to the present invention. Many different embodiments can be implemented to remotely control actions on a wireless device.

According to a specific embodiment, the Task Management Engine 230 is deployed on a server residing on the network 220 and there is a Client Application 210 (residing in the client wireless device 200) that communicates with Task Management Application 215 as needed. The Task Management Engine 230 obtains position information from Position/Location Detector 240. Whenever a position-rule needs to be executed, the Task Management Engine 230 passes the relevant information to the Task Management Application 215 so that it can communicate with the Client Application 210 to carry out the required reminder/actions. In embodiments where the wireless device 200 itself supports the Task Management Application 215 which is being accessed via a web server, Task Management Engine 230 with position information from Position/Location Detector 240 causes the Task Management Application 215 to cause the wireless device 200 to carry out the required reminders/actions, as mentioned earlier.

The above described embodiments are suitable for thin-client devices that do not require a local positioning system (such as a GPS system in the device) but whose position can be tracked by the network using device/network assisted positioning technologies. In general, the network-based deployment can use a heartbeat mechanism to keep track of the positioning information and use an intelligent periodic schedule whose frequency can be adapted to the rate of change of physical position of the device 300. Transfer of positioning information from the Task Management Application 215 to the wireless client device 200 may employ a pull mechanism or a push mechanism. In a pull mechanism, the client periodically checks via Task Management Application 215 with the Position/Location Detector 240/Task Management Engine 230 to find whether there has been any change in the position. In a push mechanism, the client subscribes to position information by sending a message via Task Management Application 215 to Position/Location Detector 240/Task Management Engine 230, which notifies the client whenever there is a change in position.

It should be noted that the network-based deployment enables the system to associate the actions with the position of multiple wireless devices (such as wireless device 200, a second wireless device 255, and other wireless devices not shown) whose positions can be tracked by the network equipment (Position/Location Detector 240/Task Management Engine 230), in accordance with another specific embodiment of the invention. A user (client) might define actions and rules that depend on the position of another wireless-device. The client maintains a device-list indicating the entities (wireless devices) that are of interest to this client. It may periodically check the network equipment of the invention to find whether there has been any change in the position of any of the desired devices in the list. In a push mechanism, the client subscribes to presence information by sending the device-list to the network equipment which notifies the client whenever there is a change in the status of any of the devices in the list. In a multi-device scenario, a user (client) might define X rules for Y number of devices and associate them with Z number of actions.

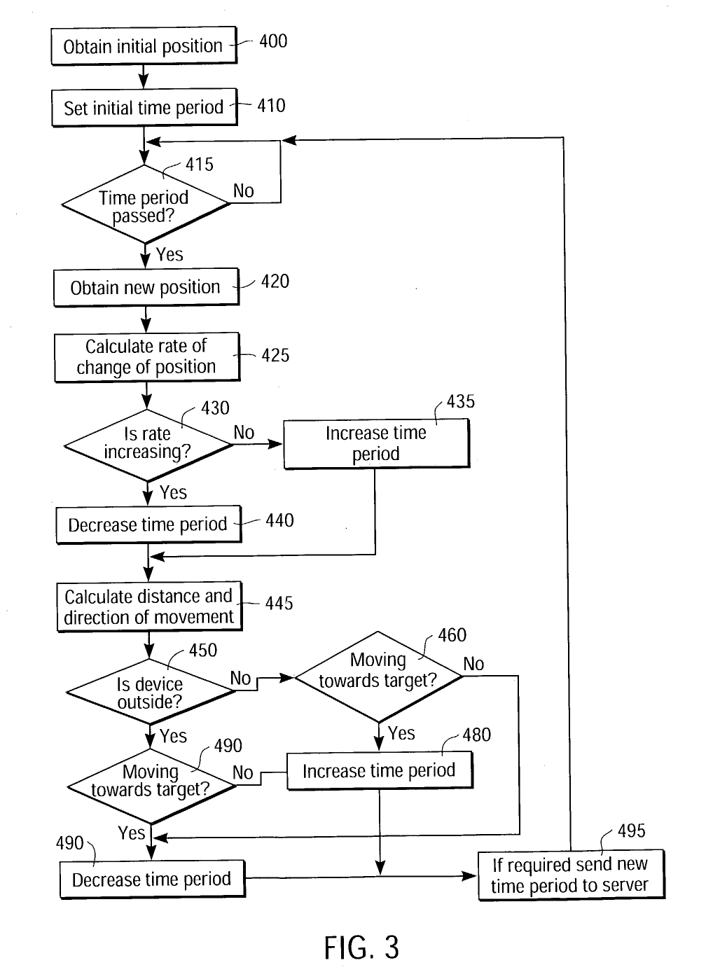

FIG. 3 shows a flow diagram for a method of controlling how often the positioning data of the particular device is transferred from the Position/Location Detector to the Task Management Engine, which generates the trigger signal to the client device to issue the reminder/action. The Task Management Engine in coordination with the Position/Location Detector use this method, which increases the position data transfer frequency when the position is changing at a rapid state or when the particular device is about to cross the boundaries that define the proximity to the target position.

According to this specific embodiment, the method starts with step 400 by obtaining an initial position information for the desired device. In step 410, an initial time period t=t0 (this initial value t0 must be small, e.g., 1 minute) is set by either a network administrator or the user in configuring the setup. In step 415, it is determined whether this set time period t=t0 has elapsed. Once it has elapsed, then new position information for the desired device is obtained in step 420. Then in step 425 the rate of change of the position information is calculated. It is determined by the system if the rate is increasing or decreasing in step 430 (this step may be skipped the first time the method is used, due to the lack of previous rate information). If the rate is increasing, then the time period t is decreased in step 440. However, if the rate is decreasing, then the time period t is increased in step 435. After an appropriate increase/decrease of the time period t in step 435/440, the system calculates the distance of the desired device from the target position and the direction of movement of the desired device in step 445.

It is determined in step 450 whether the particular device is outside the proximity of the target position. If the device is not outside the proximity and is determined in step 460 to be moving away from the target position, then the time period t is decreased in step 490. If the device is not outside the proximity and is determined in step 460 to be moving toward the target position, then the time period t is increased in step 480.

If it is determined in step 450 that the particular device is outside the proximity and is determined in step 490 to be moving towards the target position, then the time period t is decreased in step 490. However, if it is determined in step 450 that the particular device is outside the proximity and is determined in step 490 to be moving away from the target position, then the time period t is increased in step 480.

After step 480 or after step 490, the new or modified time period t is sent in step 495 to the Position/Location Detector. Then the method continues by returning to step 415.

If the user has defined a time threshold for the target position (e.g. device should remain in the proximity for at least 5 minutes), the time period t must be kept low such as to take into account the value of the time threshold for determining the new time period. This applies to steps 435 and 480.

Furthermore, the functions that are used to increase and decrease the time period t should also take into account the Minimum-Time-Period and the Maximum-Time-Period thresholds. The Minimum-Time-Period is defined by the limitation of the positioning system (Position/Location Detector system) to obtain position information within a specified time. Each system requires some minimum interval before it can determine the outputs. The Minimum-Time-Period can also be governed by the desire of the user to maintain low power consumption for the device.

The various embodiments are described as specific embodiments for ease of understanding the invention. Furthermore, the invention can be deployed on any wireless network, e.g. GSM, CDMA, TDMA, UMTS, Bluetooth, IrDA, IEEE 802.11 or other networks, and should not necessarily be construed as being limited to GSM only.

What is claimed is:

1. A system for causing a wireless device to provide a location-based task functionality, said system comprising:
a server for remotely exchanging data information with said wireless device;
a position detector logically coupled with said server, said position detector determining a position of a remote wireless device;
wherein said server generates an event trigger signal and sends said event trigger signal to said wireless device if a predefined condition based on said position is met, wherein a user of said wireless device configures said predefined condition on said server.

2. The system as in claim 1, wherein said position detector generates said position from information comprising spatial coordinates, ZIP code, telephone area code, mailing address, EOTD information, base station identifier, and/or cell site/sector identifier.

3. The system as in claim 1, wherein said predefined condition comprises said position matching a predefined location.

4. The system as in claim 1, wherein said predefined condition comprises said position being within a predefined area.

5. The system as in claim 1, wherein said predefined condition comprises said position transitioning from a first area to a second area.

6. The system as in claim 1, wherein said predefined condition is met only when said predefined condition exists for at least a predefined time period.

7. The system as in claim 1, wherein said predefined condition comprises said position mismatching a predefined area.

8. The system as in claim 7, wherein said predefined condition is met only when said predefined condition exists for at least a predefined time period.

9. The system as in claim 1, wherein said event trigger signal generates a reminder alert within said wireless device.

10. The system as in claim 1, wherein said event trigger signal causes a start of an application within said wireless device.

11. The system as in claim 1, wherein said event trigger signal activates a predefined operating mode of said wireless device.

12. The system as in claim 10, wherein said application includes an action of dialing a number, starting a web browser, downloading a file from the web, uploading a file from the web, and/or controlling a function of the wireless device.

13. The system as in claim 11, wherein said predefined operating mode selects a predefined profile of said wireless device.

14. The system as in claim 1 wherein said remote wireless device comprises said wireless device.

15. The system as in claim 1 wherein said remote wireless device is not said wireless device.

16. The system as in claim 1 wherein said server runs a Task Management Engine and a Task Management Application.

17. The system as in claim 1 wherein said server comprises a web server running a Task Management Application accessible by said user via said wireless device, wherein said Task Management Application transmits said event trigger signal to said wireless device.

18. The system as in claim 1 wherein said server runs a Task Management Application accessible by said user via another user device, such as a personal computer, laptop computer, handheld computer, or personal digital assistant; and wherein said Task Management Application transmits said event trigger signal to said wireless device.

19. The system as in claim 1 wherein said server runs a Task Management Application and said wireless device runs a Client Application, said Task Management Application communicating with said Client Application to transmit said event trigger signal.

20. The system as in claim 1 wherein said server and said position detector are maintained by a wireless service provider for a subscriber fee paid by said user, wherein said subscriber fee comprises a per-task fee or a flat periodic fee.

21. A method of operating a service using wireless network infrastructure equipment to provide a wireless device with a location-based task functionality, said method including the steps of:
determining a position of a remote wireless device, wherein said determining step is performed using said wireless network infrastructure equipment including a Position/Location Detector;
providing a server within said wireless network infrastructure equipment, said server including a Task Management Engine for administering the generation and transmission of an event trigger signal to said wireless device if a predefined condition based on said position is met; and
receiving configuration input to define said predefined condition on said server.

22. The method as in claim 21, further comprising the step of billing said user a fee for said service, wherein said fee is charged per event trigger signal being transmitted or said fee is a flat fee for a certain level of or unlimited use of said service a billing period.

23. The method as in claim 21, wherein said configuration input further defines content and/or nature of said event trigger signal.

24. The method as in claim 21, wherein said remote wireless device comprises said wireless device.

25. The method as in claim 24, wherein said remote wireless device is not said wireless device, and said remote wireless device is linked to said user of said wireless device via mutual assent.

26. The method as in claim 21, wherein the step of obtaining said position is repeated in time intervals.

27. The method as in claim 26, wherein depending on said position said time intervals are varied.

28. The method as in claim 26, wherein a direction of movement of said remote wireless device is determined from successively gathered information on said position at different times.

29. The method as in claim 21, wherein said position information is generated from information comprising spatial coordinates, ZIP code, telephone area code, mailing address, EOTD information, base station identifier, and/or cell site/sector identifier.

30. The method as in claim 21, wherein said predefined condition comprises said position matching a predefined location or predefined area.

31. The method as in claim 21, wherein said predefined condition comprises said position transitioning from a first area to a second area.

32. The method as in claim 21, wherein said predefined condition comprises said position matching a predefined location or predefined area for a predefined time period.

33. The method as in claim 21, wherein said predefined condition comprises said position mismatching a predefined area.

34. The method as in claim 21, wherein said predefined condition comprises said position mismatching a predefined area for a predefined time period.

35. The method as in claim 21, wherein said event trigger signal generates a reminder alert within said wireless device.

36. The method as in claim 21, wherein said event trigger signal causes a start of an application within said wireless device.

37. The method as in claim 21, wherein said event trigger signal activates a predefined operating mode of said wireless device.

38. The method as in claim 36, wherein said application includes an action of dialing a number, starting a web browser, downloading a file from the web, uploading a file from the web, and/or controlling a function of said wireless device.

39. The method as in claim 37, wherein said predefined operating mode selects a predefined profile of said wireless device.
